(19) United States
(12) Patent Application Publication
(10) Pub. No.: US 2013/0210249 A1
(43) Pub. Date: Aug. 15, 2013

(54) CONVERTER AND PROGRAM

(71) Applicant: Sony Corporation, (US)

(72) Inventors: Kazuyoshi Takemura, Tokyo (JP); Kuniya Hayashi, Tokyo (JP); Takanori Washiro, Kanagawa (JP); Isao Soma, Saitama (JP); Kayoko Tanaka, Tokyo (JP); Yoichiro Sako, Tokyo (JP); Kazutoshi Serita, Tokyo (JP); Satoshi Higano, Kanagawa (JP)

(73) Assignee: Sony Corporation, Tokyo (JP)

(21) Appl. No.: 13/760,382

(22) Filed: Feb. 6, 2013

(30) Foreign Application Priority Data
Feb. 13, 2012 (JP) 2012-028784

(51) Int. Cl. G05B 1/01

(52) U.S. Cl. CPC G05B 1/01
USPC 439/170; 340/5.6

(57) ABSTRACT

There is provided a converter including a connecting terminal connectable to a connecting device, a communicating unit capable of carrying out communication, and a communication restricting unit configured to restrict the communication carried out by the communicating unit if the connecting device is removed from the connecting terminal.

### BACKGROUND

The present disclosure relates to a converter and a program.

As disclosed in JP 2003-110471A, for example, more authentication outlets and more authentication plugs are currently used. Such authentication outlets and authentication plugs authenticate each other through mutual communications therebetween.

### SUMMARY

Unfortunately, the authentication outlets and authentication plugs are in a transitional period, and in some cases, one connecting device (a plug, for example) is not compatible with the other connecting device (an outlet, for example) for the communication. Hence, such a technology has been desired that allows connecting device to carry out desirable communication.

According to an embodiment of the present disclosure, there is provided a converter which includes a connecting terminal connectable to a connecting device, a communicating unit capable of carrying out communication, and a communication restricting unit configured to restrict the communication carried out by the communicating unit if the connecting device is removed from the connecting terminal.

According to an embodiment of the present disclosure, there is provided a program that allows a computer to realize a communication restricting function for restricting communication carried out by a communicating unit if a connecting device connectable to a connecting terminal is removed from the connecting terminal.

According to an embodiment of the present disclosure, the converter includes the communicating unit, so as to allow the connecting device to carry out desired communication.

The present disclosure as described above allows the connecting device to carry out desired communication.

### BRIEF DESCRIPTION OF THE DRAWINGS

FIG. 1 is a cross sectional view showing a configuration of a converter and others according to an embodiment of the present disclosure;

FIG. 2 is a side view showing a configuration of a fixing member;

FIG. 3 is a cross sectional view showing a configuration of the converter and others;

FIG. 4 is a cross sectional view showing a configuration of the converter and others;

FIG. 5 is a functional block diagram showing a first application example according to the present embodiment;

FIG. 6 is a functional block diagram showing the first application example according to the present embodiment;

FIG. 7 is a functional block diagram showing the first application example according to the present embodiment;

FIG. 8 is a functional block diagram showing the first application example according to the present embodiment;

FIG. 9 is a functional block diagram showing a second application example according to the present embodiment;

FIG. 10 is a functional block diagram showing the second application example according to the present embodiment;

FIG. 11 is a functional block diagram showing the second application example according to the present embodiment;

FIG. 12 is a functional block diagram showing the second application example according to the present embodiment;

FIG. 13 is a functional block diagram showing the second application example according to the present embodiment;

FIG. 14 is a functional block diagram showing the second application example according to the present embodiment;

FIG. 15 is a functional block diagram showing a third application example according to the present embodiment; and

FIG. 16 is a functional block diagram showing a fourth application example according to the present embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Description will be provided in the following order.
1. Outline
2. Configuration of converter and others
3. Application method of fixing member
4. First application example
5. Second application example
6. Third application example
7. Fourth application example

### 1. Outline

The present embodiment allows each connecting device to carry out desirable communication, specifically, wireless communication or power line communication.

In the wireless communication and the power line communication of the present embodiments, techniques pertinent to the NFC (near field communication) and the RFID (radio frequency identification) are used, and the technology according to the present disclosure may also be applicable to wireless communications and power line communications other than these techniques. The power line communication of the present embodiments includes communication carried out through a contact between terminals of each device (so-called contact communication), and communication carried out by connecting terminals of each device with wires.

The power line communication of the present embodiments employs techniques pertinent to the NFC and the RFID, so that the following effects may be expected. Specifically, wired communication using an existing PLC technique requires a communicating device including a relatively large circuit such as a so-called PLC modem, for example. Hence, such wired communication using the existing PLC technique may increase in cost for the communicating device, and may also limit the size of the communicating device. In addition, in the wired communication using the existing PLC technique, no communication is available if no power (power signal) is fed to the communicating device (out of operation because a main power is OFF, for example).

A communicating device used in the NFC and in the RFID has a much smaller circuit compared to that of the existing PLC modem; therefore, such a communicating device may be reduced in size into an IC (integrated circuit) chip, for example. Since more wireless communication devices (such as mobile phones) including such communicating devices have been spread well, the above communicating device becomes inexpensive compared to the existing PLC modem.

In addition, in the techniques pertinent to the NFC and the RFID, one of wireless communicating devices supplies a high frequency signal to the other of the wireless communicating devices, thereby supplying power to the other wireless communicating device. The other communicating device operates with the supplied power, and carries out load modulation, thereby transmitting stored information.

The power line communication according to the present embodiments realizes reduction in size of power line communicating device (such as a converter and an outlet described later, for example), and allows reduction in manufacturing cost thereof. In addition, since each power line communicating device operates with a high frequency signal, the power line communicating devices communicate with each other even if no power is supplied for the power line.

A frequency of the high frequency signal may include at least one of 130 to 135 kHz, 13.56 MHz, 56 MHz, 433 MHz, 954.2 MHz, 954.8 MHz, 2441.75 MHz, and 2448.875 MHz, but the frequency of the high frequency signal according to the present embodiments may not be limited to these frequencies. It is preferred that the frequency of the high frequency signal is at least different from the frequency of the power signal (50 Hz or 60 Hz).

### 2. Configuration of Converter and Others

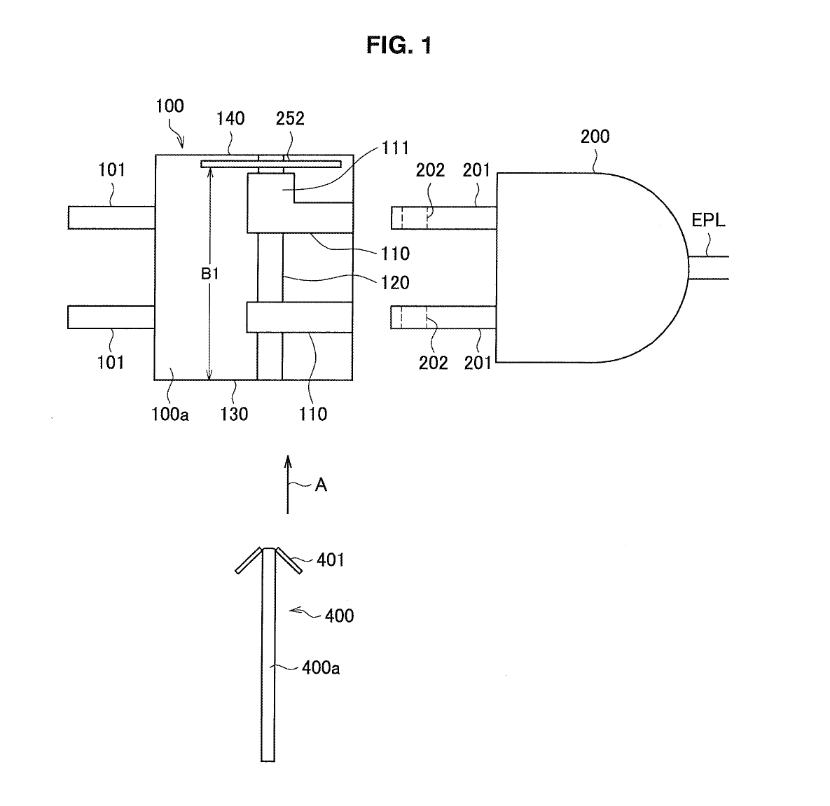

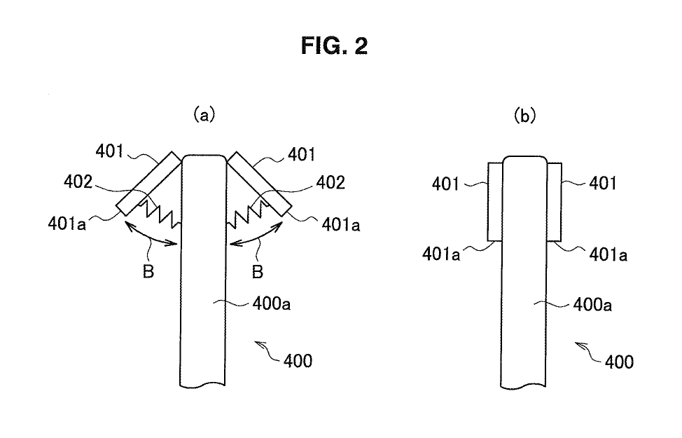

With reference to FIG. 1, FIG. 2(a), and FIG. 2(b) description will now be provided on a converter 100 and a plug 200 (connecting device). The converter 100 includes a converter body 100a, blade terminals (projections) 101, apertures (connecting terminals) 110, an auxiliary fixing member movable space 111, a second through hole 120, an IC chip (communicating unit) 252, and a fixing member 400. The second through hole 120 and the fixing member 400 constitute a communication restricting unit. The converter body 100a includes the apertures 110, the auxiliary fixing member movable space 111, the second through hole 120, and the IC chip 252. The blade terminals 101 are disposed at a tip end of the converter body 100a, and are connected to an outlet.

The blade terminals (projections) 201 of the plug 200 are inserted into the apertures 110. The apertures 110 have no mechanism of fixing the blade terminals 201. The fixation of the blade terminals 201 in the apertures 110 is accomplished by the fixing member 400. The auxiliary fixing member movable space 111 is disposed at a position in vicinity of the IC chip 252. Each auxiliary fixing member 401 described later is movable in the auxiliary fixing member movable space 111. The auxiliary fixing member movable space 111 is coupled with the apertures 110.

The second through hole 120 is a hole into which the fixing member 400 described later is inserted, and is formed to extend from one side face 130 to the other side face 140 of the converter body 100a. In addition, the second through hole 120 extends through the apertures 110 and the auxiliary fixing member movable space 111. The IC chip 252 communicates with the outlet, and is disposed in vicinity of the side face 140 of the converter body 100a. The IC chip 252 blocks the second through hole 120. The IC chip 252 stores information regarding electronic equipment connected to the plug 200. Writing of information on the IC chip 252 may be executed by a user, but it is preferable to restrict the writing by the user in the light of preventing an unauthorized act described later. A protective cap for protecting the IC chip 252 may be provided on an aperture face of the second through hole 120, particularly on the aperture face of the side face 140 thereof.

The fixing member 400 includes a base body 400a, the auxiliary fixing members 401, and flexible members 402 as shown in FIG. 1, FIG. 2(a) and FIG. 2(b). The base body 400a is a stick-like member, and has a length substantially equal to the distance B1 from the side face 130 of the converter body 100a to the IC chip 252. The auxiliary fixing member 401 is a stick-like member, and its one end is fixed to a tip end of the base body 400a. The auxiliary fixing member 401 is movable (rotatable) in the arrow B direction around the tip end of the base body 400a. The present embodiment provides two auxiliary fixing members 401 to the base body 400a, but the number of the auxiliary fixing members 401 is not limited to two. The movable range of each auxiliary fixing member 401 is a range shown in FIG. 2(a) and FIG. 2(b).

When a tip end 401a of each auxiliary fixing member 401 comes into the state of FIG. 2(a) (open state), the distance between the tip ends 401a of the auxiliary fixing members 401 becomes greater than the inner diameters of each first through hole 202 and the second through hole 120 as described later. On the other hand, when each auxiliary fixing member 401 comes into the state of FIG. 2(b) (closed state), the distance between the tip ends 401a of the auxiliary fixing members 401 becomes equal to or smaller than the inner diameters of each first through hole 202 and the second through hole 120 as described later. Each flexible member 402 couples the auxiliary fixing member 401 to the base body 400a, and urges the auxiliary fixing member 401 apart from the base body 400a. Specifically the auxiliary fixing members 401 are normally in the open state if no outer force other than the outer force of the flexible members 402 is applied to the auxiliary fixing members 401.

The plug 200 includes blade terminals 201 and first through holes 202. The blade terminals 201 are inserted into the apertures 110. Each first through hole 202 is formed at the tip end of each blade terminal 201 so as to extend through the blade terminal 201. The inner diameter of each first through hole 202 is substantially equal to the inner diameter of the second through hole 120. The first through holes 202 are coupled with the second through hole 120 when the blade terminals 201 are inserted into the respective apertures 110. The electronic equipment is connected to the plug 200 through an external power line EPL.

### 3. Application Method of Fixing Member

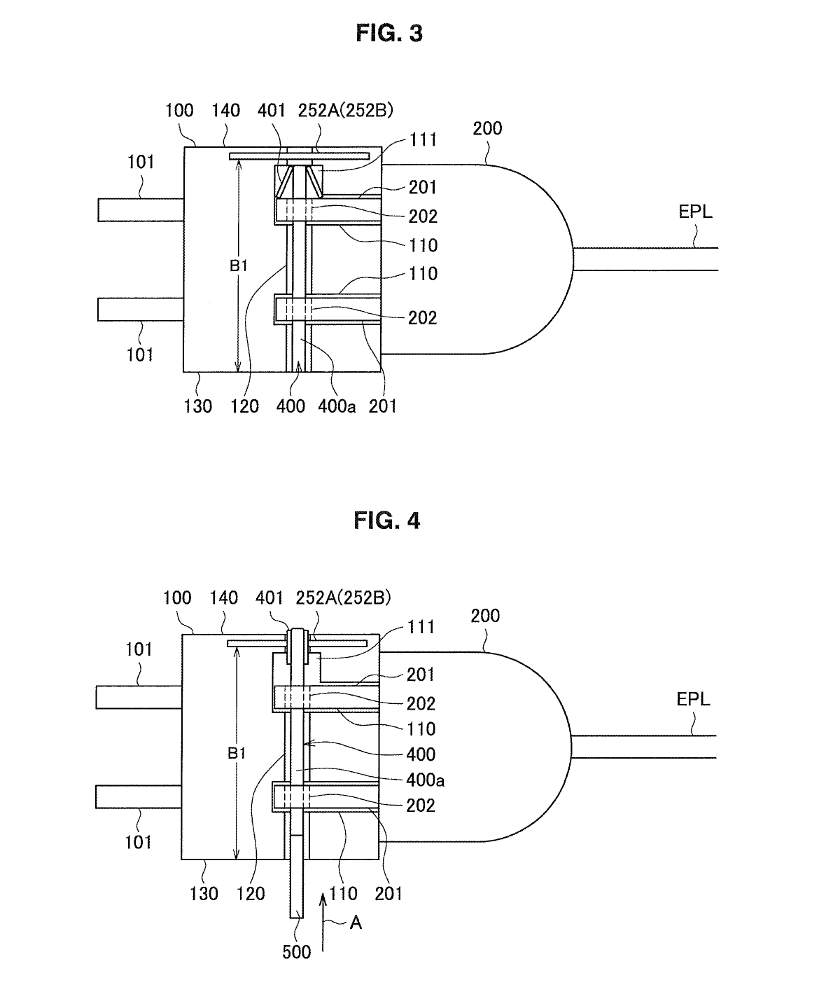

Description will now be provided on an application method of the fixing member 400 with reference to FIG. 3 and FIG. 4. As shown in FIG. 3, the user inserts the blade terminals 201 into the apertures 110, so that the first through holes 202 are coupled with the second through hole 120. The user then inserts the fixing member 400 into the second through hole 120. At this time, the auxiliary fixing members 401 are pushed by the outer wall of the second through hole 120 so as to come into the state of FIG. 2(b), which allows the fixing member 400 to progress in the second through hole 120 in the arrow A direction. When the fixing member 400 is completely inserted in the second through hole 120, the tip end of the fixing member 400 is located in front of the IC chip 252. The auxiliary fixing members 401 come into the open state in the auxiliary fixing member movable space 111. Consequently, the fixing member 400 becomes unmovable in a reverse direction to the arrow A direction. In other words, the fixing member 400 is fixed in the first through holes 202 and the second through hole 120. Accordingly the plug 200 is fixed to the converter 100.

If the user desires to remove the plug 200 from the converter 100, the user inserts an unlocking member 500 (stick-like member) into the second through hole 120 as shown in FIG. 4, and moves the unlocking member 500 in the arrow A direction. The fixing member 400 moves in the arrow A direction so as to destroy the IC chip 252, and then projects from the side face 140. Thereafter, the user may remove the fixing member 400 from the converter 100.

As described above, in the present embodiment, the plug 200 does not come off the converter 100 until the IC chip 252 is destroyed. The reason for this is as follows. Specifically, the present inventors have developed a system of determining electricity charges for each electronic equipment by applying wireless communication or power line communication. In such a system, the IC chip 252 communicates with the outlet 300A and others when the converter 100 is connected to the outlet 300A and others. Through this connection, the outlet 300A and others acquire information recorded on the IC chip 252, that is, information regarding the electronic equipment in this case. The outlet 300A and others transmit this information to a server. The server stores an association table between types of the electric equipment and electricity charges per electric power consumption rate, calculates the electricity charge based on the association table, the information provided by the outlet 300A and on the electric power supplied for the electronic equipment, and charges the user for the calculated electricity charge.

Hence, if inconsistency occurs between the information stored on the IC chip 252 and the electronic equipment connected to the converter 100 through the plug 200, the user is incorrectly charged for the electricity. For example, the user may resister electronic equipment having an inexpensive electricity charge per electric power consumption rate on the IC chip 252, and use another electronic equipment having a more expensive electricity charge per electric power consumption rate by connecting this electronic equipment to the converter 100. For this reason, in the present embodiment, the plug 200 is configured to be unremovable from the converter 100 until the IC chip 252 is destroyed. In order to prevent such an unauthorized act, the IC chip 252 may be configured to prevent rewriting of information by the user. In this case, the converter 100 is provided for each type of the electronic equipment, so that the user is supposed to acquire the converter 100 corresponding to the electronic equipment that the user desires to use. The server compares the waveform of the electric signal and the information provided by the outlet 300A, so as to confirm that there is no inconsistency therebetween.

For the above purpose, if the plug 200 is removed from the converter 100, the communication carried out by the IC chip 252 may be restricted in any manner. For example, the IC chip 252 may be configured to block the communication in any manner. Specifically, the IC chip 252 monitors a connection state between the plug 200 and the converter 100, and clears all the information stored on the IC chip 252 if the plug 200 is removed from the converter 100. Alternatively, a data processing unit 262 may stop generating a high frequency response signal or the like if the plug 200 is removed from the converter 100. The program used for this processing may be stored on a ROM 266, for example, and the data processing unit 262 reads and executes this program. Particularly important components of the IC chip 252 such as the data processing unit 262, the ROM 266, a RAM 268, and an inner memory 270, which will be described later, are preferably disposed in the second through hole 120. This configuration allows the fixing member 400 to more securely destroy these components.

### 4. First Application Example

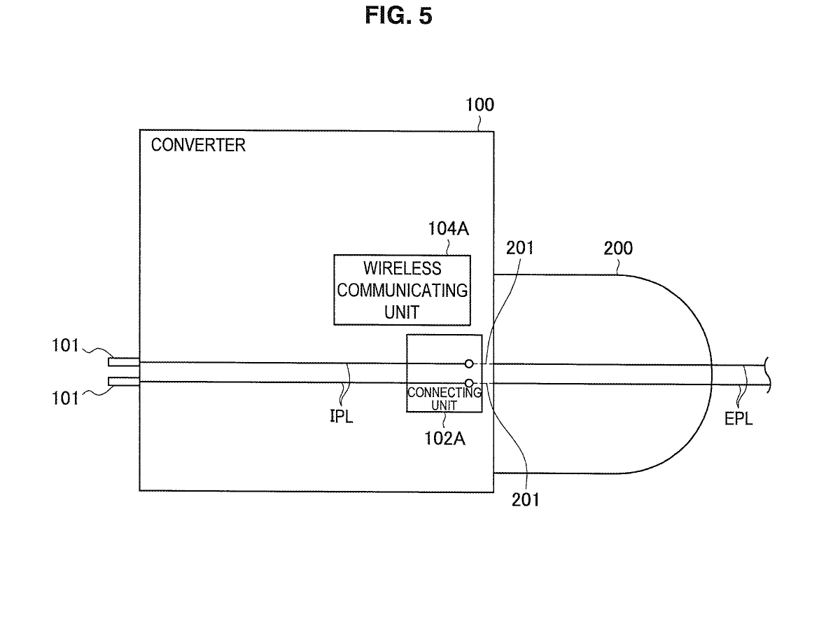

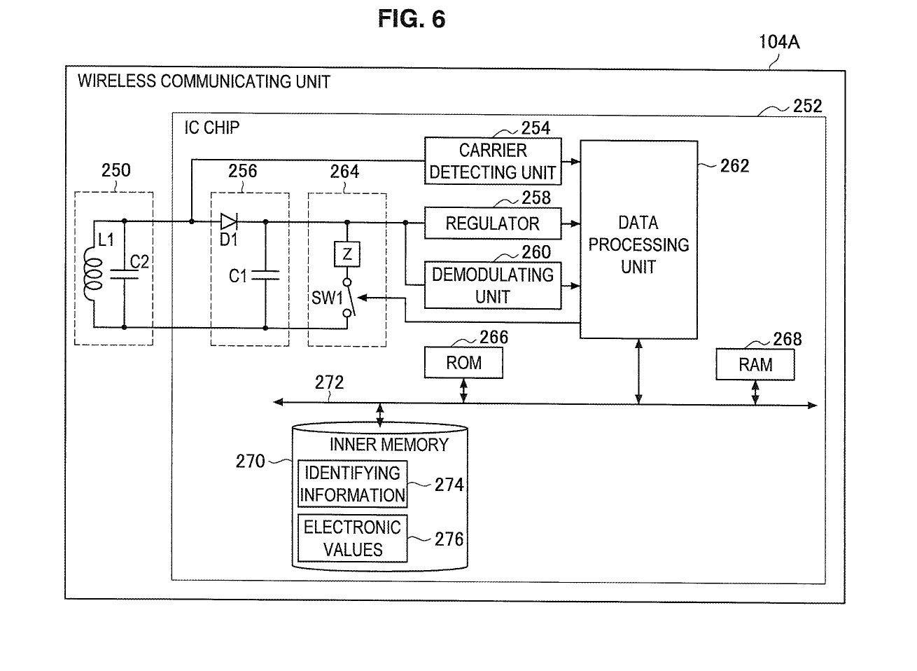

Hereinafter, description will be provided on each application example according to the present embodiment. With reference to FIG. 5 to FIG. 8, the first application example will now be described. The converter 100 includes blade terminals 101, a connecting unit 102A, a wireless communicating unit 104A, and an internal power line IPL. The converter 100 adjusts the plug 200 to be available for the wireless communication. The connecting unit 102A includes the above described apertures 110. The internal power line IPL connects the apertures 110 to the blade terminals 101. The wireless communicating unit 104A includes the IC chip 252 and a high frequency transceiver 250, as shown in FIG. 6.

The IC chip 252 includes a detecting unit 254, a wave detecting unit 256, a regulator 258, a demodulating unit 260, a data processing unit 262, and a load modulating unit 264. Although not shown in FIG. 6, the IC chip 252 may further include a protective circuit (not shown) for preventing excessive voltages or excessive currents from being applied to the data processing unit 262. An example of the protective circuit (not shown) may include a clamping circuit constituted by diodes or the like, for example.

The IC chip 252 includes a ROM 266, a RAM 268, and an inner memory 270, etc. The data processing unit 262 is connected to the ROM 266, the RAM 268, and the inner memory 270 via a bus 272 as a data path, for example.

The ROM 266 stores control data such as programs and operation parameters to be used by the data processing unit 262. The RAM 268 temporarily stores the programs to be executed by the data processing unit 262, calculation results, execution statuses, and others.

The inner memory 270 is a storage unit included in the IC chip 252, and may have a tamper resistance, for example, and reading, writing, or updating of data is carried out on the inner memory 270 by the data processing unit 262. The inner memory 270 stores various data such as identifying information (identifying information of electronic equipment to which the plug 200 is connected), electronic values, and application data. FIG. 6 shows an example of the inner memory 270 that stores the identifying information 274 and electronic values 276 of the electronic equipment.

The detecting unit 254 generates a detecting signal in square waves, for example, based on the high frequency signal, and transmits the detecting signal to the data processing unit 262. The data processing unit 262 uses the transmitted detecting signal as a processing clock for data processing, for example. The above detecting signal is generated based on the high frequency signal transmitted from the outlet 300A described later, therefore, this detecting signal is synchronized with the frequency of the high frequency signal. The IC chip 252 includes the detecting unit 254, which allows the processing with the outlet 300A to be synchronized with the outlet 300A.

The wave detecting unit 256 rectifies the voltage in accordance with the received high frequency signal (also referred to as a “received voltage”, hereinafter). The wave detecting unit 256 may be constituted by a diode D1 and a capacitor C1, for example, but the configuration of the wave detecting unit 256 is not limited to this.

The regulator 258 smoothens and regulates the received voltage as a driving voltage, and then transmits the driving voltage to the data processing unit 262. The regulator 258 is capable of using a direct current component of the received voltage as the driving voltage.

The demodulating unit 260 demodulates the high frequency signal based on the received voltage, and transmits data corresponding to the high frequency signal (data signal binarized into a high level and a low level). The demodulating unit 260 is capable of transmitting an AC component of the received voltage as data.

The data processing unit 262 operates with the driving voltage transmitted from the regulator 258 as the power source, and processes data demodulated on the demodulating unit 260. The data processing unit 262 may be constituted by the MPU, for example, but the configuration of the data processing unit 262 is not limited to this.

The data processing unit 262 selectively generates a control signal for controlling the load modulation pertinent to a response to the outlet 300A based on the processing results. The data processing unit 262 also selectively transmits the control signal to the load modulating unit 264.

The load modulating unit 264 includes a load Z and a switch SW1, for example, and selectively connects (enables) the load Z in accordance with the control signal transmitted from the data processing unit 262, so as to carry out the load modulation. The load Z may be constituted by a resistance having a predetermined resistance value, but the configuration of the load Z is not limited to this. The switch SW1 may be constituted by a p-channel MOSFET (metal oxide semiconductor field effect transistor), or an n-channel MOSFET, for example, but the configuration of the switch SW1 is not limited to this.

In the above configuration, the IC chip 252 processes the received high frequency signal, and superimposes and transmits the high frequency response signal on the power line through the load modulation. It is needless to say that the configuration of the IC chip 252 according to the present embodiment is not limited to the configuration of FIG. 6.

The high frequency transceiver 250 includes a coil L1 having a predetermined inductance, and a capacitor C2 having a predetermined electrostatic capacity, which constitute a resonant circuit. The resonant frequency of the high frequency transceiver 250 may be a frequency of a high frequency signal of 13.56 [MHz], for example. In the above configuration, the high frequency transceiver 250 receives a high frequency signal transmitted from an outlet 300A described later, and transmits a high frequency response signal to the outlet 300A. Specifically, the high frequency transceiver 250 generates an induced voltage by electromagnetic induction in response to the receipt of the high frequency signal, and transmits the received voltage generated by resonant oscillations of the induced voltage at a predetermined resonant frequency to the IC chip 252. The high frequency transceiver 250 transmits the high frequency response signal transmitted from the IC chip 252 through the load modulation to the outlet 300A.

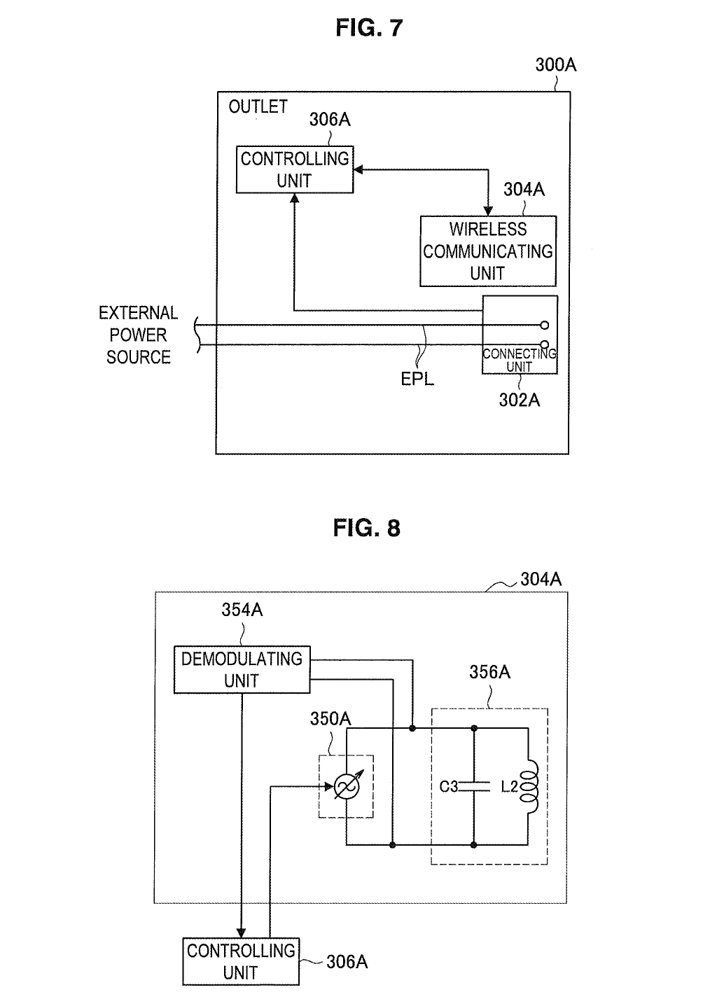

The converter 100 is connected to the outlet 300A shown in FIG. 7, for example. The outlet 300A is an example of the connecting device having a wireless communicating function, and includes a connecting unit 302A, a wireless communicating unit 304A, a controlling unit 306A, and an external power line EPL.

The connecting unit 302A includes apertures. The blade terminals 101 of the converter 100 are inserted into these apertures, and these apertures are connected to the external power line EPL. The connecting unit 302A may transmit a connection confirming signal to the controlling unit 306A when the converter 100 is connected to the connecting unit 302A. The external power line EPL connects the connecting unit 302A to the external power source.

The wireless communicating unit 304A carries out wireless communication with the wireless communicating unit 104A described above, and functions as a reader/writer (or interrogator) in the NFC or the like. Specifically, as shown in FIG. 8, the wireless communicating unit 304A includes a high frequency signal generating unit 350A, a demodulating unit 354A, and a high frequency transceiver 356A. The wireless communicating unit 304A may further include an encoding circuit (not shown) and a communication collision preventing (anti-collision) circuit, or the like, for example.

In response to the high frequency signal generating instruction transmitted from the controlling unit 306A, for example, the high frequency signal generating unit 350A generates the high frequency signal in accordance with the high frequency signal generating instruction. In response to the high frequency signal transmission-stop instruction indicating transmission stop of the high frequency signal that is transmitted from the controlling unit 306A, for example, the high frequency signal generating unit 350A stops generating the high frequency signal.

FIG. 8 shows an AC power source as the high frequency signal generating unit 350A, but the high frequency signal generating unit 350A according to the present embodiment is not limited to this. For example, the high frequency signal generating unit 350A according to the present embodiment may include a modulating circuit (not shown) for carrying out an ASK (amplitude shift keying) modulation, and an amplifier circuit (not shown) for amplifying the transmission from the modulating circuit. The high frequency signal generated by the high frequency signal generating unit 350A includes transmission request for the plug 200 to transmit identifying information, and various processing instruction for the plug 200 for, example.

The demodulating unit 354A detects variation in voltage amplitude at the antenna end of the high frequency signal generating unit 350A through an envelope detection, and binarizes the detected signal, so as to demodulate the high frequency response signal transmitted from the wireless communicating unit 104A. The method of demodulating the high frequency response signal on the demodulating unit 354A is not limited to this, and the response signal may be demodulated using the phase shift of the voltage at the antenna end of the high frequency signal generating unit 350A.

The high frequency transceiver 356A includes an inductor (coil) L2 having a predetermined inductance and a capacitor C3 having a predetermined electrostatic capacity, which constitutes a resonant circuit, for example. The resonant frequency of the high frequency transceiver 356A may be a frequency of a high frequency signal of 13.56 [MHz], for example. In the above configuration, the high frequency transceiver 356A transmits the high frequency signal generated by the high frequency signal generating unit 350A, and receives the high frequency response signal transmitted from the wireless communicating unit 104A.

The controlling unit 306A may be constituted by an MPU (micro processing unit) or an integrated circuit in which various processing circuits are integrated, and controls each unit of the converter 100. More specifically, the controlling unit 306A transmits the high frequency signal generating instruction and the high frequency signal transmission-stop instruction to the wireless communicating unit 304A, and executes various processing (management of electronic values, etc.) based on the high frequency response signal transmitted from the wireless communicating unit 304A. The controlling unit 306A may transmit the high frequency signal generating instruction to the wireless communicating unit 304A when the connection confirming signal is provided by the connecting unit 302A. The controlling unit 306A has the same specific configuration as that of the above described controlling unit 306A.

Through the above configuration, the converter 100 converts the communication mode of the plug 200 from no communication to the wireless communication. Specifically, the converter 100 transmits the high frequency response signal to the outlet 300A through the wireless communication. The converter 100 receives the high frequency signal transmitted from the outlet 300A. Accordingly, the converter 100 adjusts the plug 200 to be available for the wireless communication. Through this configuration, the plug 200 becomes available to the user even in the environment in which only the wireless communication is available to the user. In the first application example, the converter 100 may not include the blade terminals 101. In this case, the converter 100 carries out wireless communication with a wireless communicating device having the wireless communicating function. This configuration is also applicable to the third application example described later.

### 5. Second Application Example

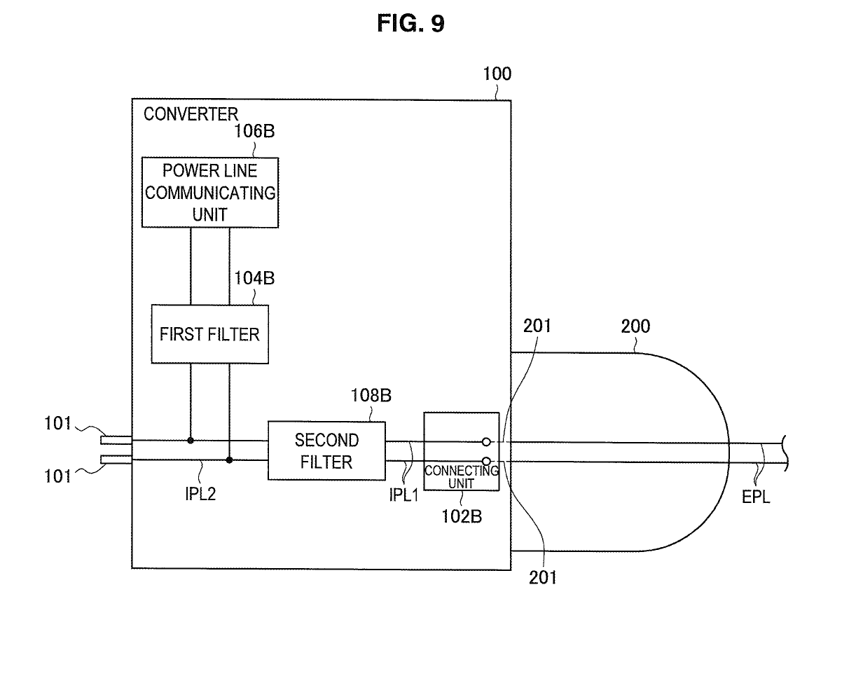

With reference to FIG. 9 to FIG. 14, the second application example will now be described. The converter 100 includes the blade terminals 101, a connecting unit 102B, a first filter 104B, a power line communicating unit 106B, a second filter 108B, and internal power lines IPL1, IPL2. The converter 100 converts the communication mode of the plug 200 from no communication to the power line communication. Specifically, the converter 100 adjusts the plug 200 to be available for the power line communication. The connecting unit 102B includes the above described apertures 110. The apertures 110 are connected to the second filter 108B through the internal power line IPL. The internal power line IPL2 connects the blade terminals 101 to the second filter 108B.

The first filter 104B is connected between the power line communicating unit 106B and the internal power line IPL2, and has a functions for filtering the signals transmitted from the internal power line IPL2. More specifically, the first filter 104B has a function for blocking the power signal without blocking the high frequency signal and the high frequency response signal among the signals transmitted from the internal power line IPL2.

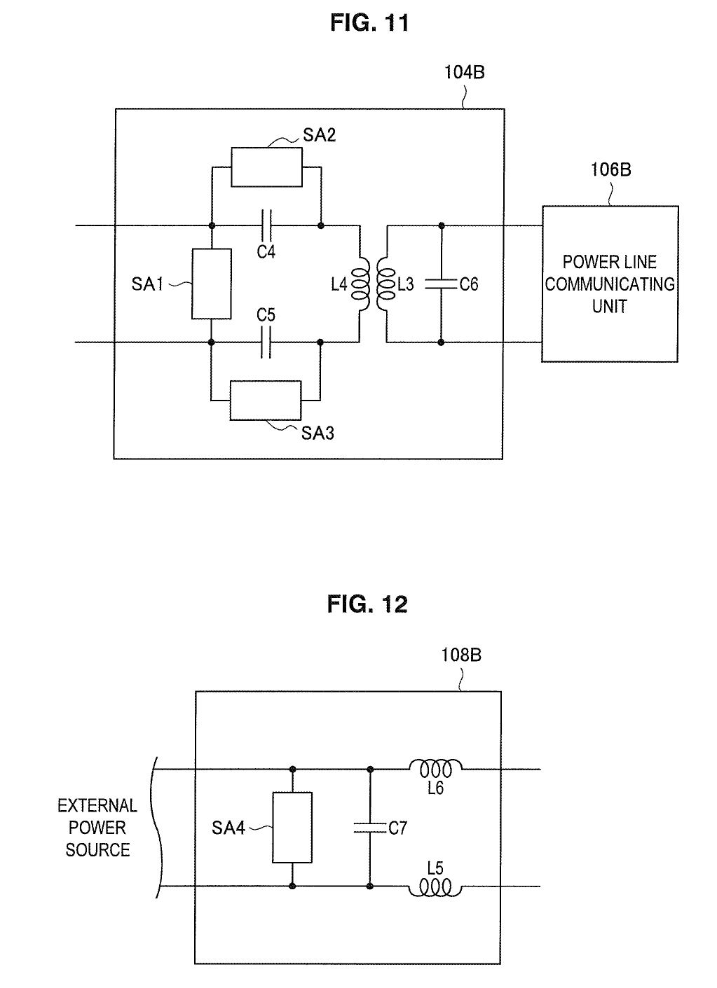

The first filter 104B includes inductances L3, L4, capacitors C4 to C6, and surge absorbers SA1 to SA3, as shown in FIG. 11. It is needless to say that the configuration of the first filter 104B according to the present embodiment is not limited to the configuration of FIG. 11.

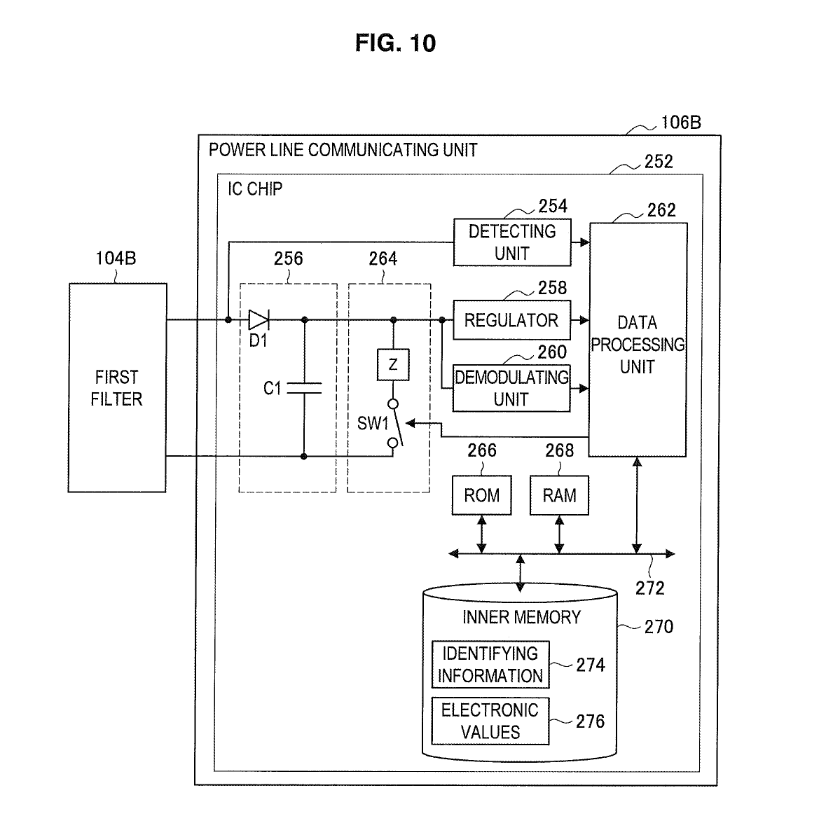

The power line communicating unit 106B is constituted by the IC chip 252, as shown in FIG. 10. Specifically, the power line communicating unit 106B operates with the high frequency signal provided by the first filter 104B, and transmits the high frequency response signal in accordance with the high frequency signal through the load modulation to the first filter 104B.

The second filter 108B connects the internal power line IPL1 and the internal power line IPL2. The second filter 108B functions for filtering the signals to be transmitted through the internal power line IPL2. More specifically, the second filter 108B has a function for blocking the high frequency signal transmitted from an outlet 300B described later and the high frequency response signal transmitted from the power line communicating unit 106B without blocking the power signal supplied through the internal power line IPL2. Specifically, the second filter 108B transmits the power signal from the outlet 300B to the electronic equipment when the converter 100 is inserted into the outlet 300B, and the plug 200 is connected to the converter 100, for example. In other words, the second filter 108B functions as a power splitter.

FIG. 12 shows an explanatory view showing an example of the configuration of the second filter 108B. The second filter 108B includes inductors L5, L6, a capacitor C7, and a surge absorber SA4. It is needless to say that the configuration of the second filter 108B according to the present embodiment is not limited to the configuration of FIG. 12.

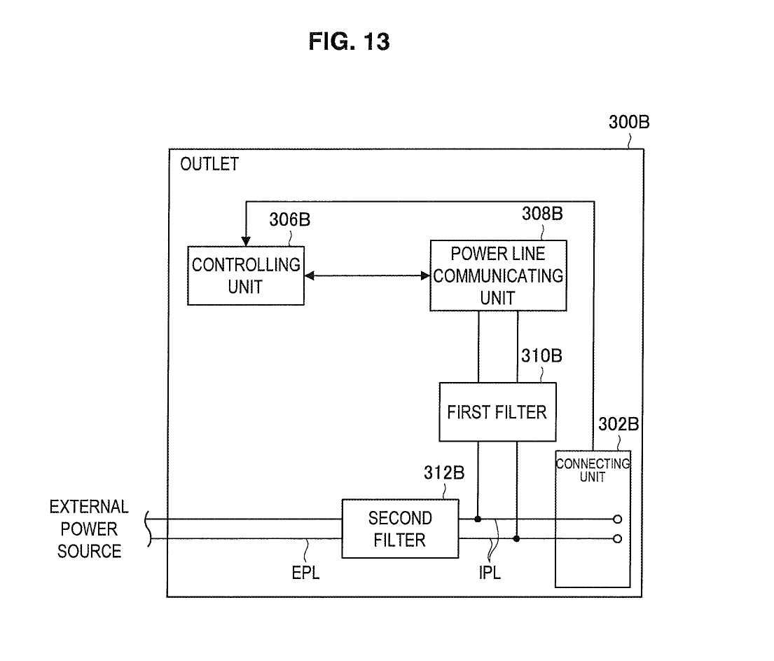

The converter 100 is connected to the outlet 300B shown in FIG. 13, for example. The outlet 300B is detachably attached to the converter 100 although not shown in FIG. 13. The outlet 300B includes a connecting unit 302B, a controlling unit 306B, a power line communicating unit 308B, a first filter 310B, a second filter 312B, the internal power line IPL, and the external power line EPL. The outlet 300B communicates with the converter 100 through the power line communication.

The connecting unit 302B includes apertures. These apertures are connected to the internal power line IPL. The connecting unit 302B is a component where the converter 100 is detachably attached, and may transmit the connection confirming signal to the controlling unit 306B when the converter 100 is connected to the connecting unit 302B. The internal power line IPL connects the connecting unit 302B to the second filter 312B.

The controlling unit 306B may be constituted by an MPU (micro processing unit) or an integrated circuit in which various processing circuits are integrated, and controls each unit of the outlet 300B. More specifically, the controlling unit 306B transmits the high frequency signal generating instruction and the high frequency signal transmission-stop instruction to the power line communicating unit 308B, and executes various processing (management of electronic values, etc.) based on the high frequency response signal transmitted from the power line communicating unit 308B. The controlling unit 306B may transmit the high frequency signal generating instruction to the power line communicating unit 308B when the connection confirming signal is provided by the connecting unit 302B. The controlling unit 306B has the same specific configuration as that of the above described controlling unit 306A.

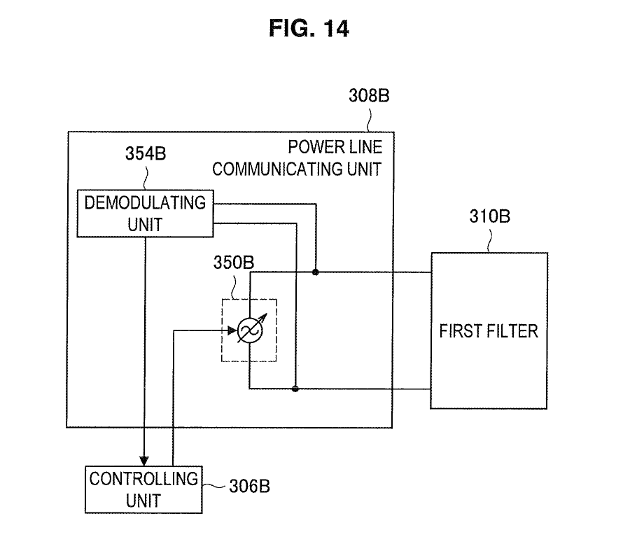

The power line communicating unit 308B carries out the power line communication with the above described outlet 200, and functions as a reader and writer (or an interrogator) in the NFC or the like. As shown in FIG. 14, the power line communicating unit 308B includes a high frequency signal generating unit 350B and a demodulating unit 354B. The power line communicating unit 308B may further include an encoding circuit (not shown) and a communication collision preventing (anti-collision) circuit, and others, for example.

The high frequency signal generating unit 350B carries out the same processing as that of the above described high frequency signal generating unit 350A. Specifically, in response to the high frequency signal generating instruction transmitted from the controlling unit 306B, the high frequency signal generating unit 350B generates the high frequency signal in accordance with the high frequency signal generating instruction. In response to the high frequency signal transmission-stop instruction indicating transmission stop of the high frequency signal that is transmitted from the controlling unit 306B, for example, the high frequency signal generating unit 350B stops generating the high frequency signal.

The demodulating unit 354B detects variation in voltage amplitude between the high frequency signal generating unit 350B and the first filter 310B through an envelope detection, and binarizes the detected signal, so as to demodulate the high frequency response signal transmitted from the converter 100. The demodulating unit 354B transmits the demodulated high frequency response signal to the controlling unit 306B. The method of demodulating the high frequency response signal on the demodulating unit 354B is not limited to the above method, and the high frequency response signal may be demodulated using the phase shift of voltage between the high frequency signal generating unit 350B and the first filter 310B.

The first filter 310B is connected between the power line communicating unit 308B and the internal power line IPL, so as to function for filtering the signals transmitted from the internal power line IPL. More specifically, the first filter 310B has a function for blocking the power signal without blocking the high frequency signal and the high frequency response signal among the signals transmitted from the internal power line IPL. Through this configuration, the first filter 310B prevents the power signal that may be noises to the power line communicating unit 308B from reaching the power line communicating unit 308B. The specific configuration of the first filter 310B is the same as that of the above described first filter 104B.

The second filter 312B connects the internal power line IPL to the external power line EPL. The external power line EPL is connected to the external power source. The second filter 312B functions for filtering the signals to be transmitted through the internal power line IPL. More specifically, the second filter 312B has a function for blocking the high frequency response signal transmitted from the converter 100 and the high frequency signal transmitted from the power line communicating unit 308B without blocking the power signal supplied from the external power source.

Specifically, the second filter 312B transmits the power signal from the external power source to the electronic equipment when the converter 100 is connected to the outlet 300B, and the plug 200 is connected to the converter 100, for example. In other words, the second filter 312B functions as a so-called power splitter. The specific configuration of the second filter 312B is the same as that of the above described second filter 108B.

Through the above configuration, the converter 100 carries out the power line communication with the outlet 300B. For example, the connecting unit 302B transmits the connection confirming signal to the controlling unit 306B when the blade terminals 101 of the converter 100 are inserted into the apertures. In response to this connection confirming signal, the controlling unit 306B transmits the high frequency signal generating instruction to the power line communicating unit 308B. The power line communicating unit 308B transmits the high frequency signal based on this instruction. The high frequency signal reaches the converter 100 through the first filter 310B and the internal power line IPL. The high frequency signal then reaches the power line communicating unit 106B through the internal power line IPL2 and the first filter 104B of the converter 100. The power line communicating unit 106B operates with this high frequency signal. The power line communicating unit 106B generates the high frequency response signal through the load modulation, and transmits this high frequency response signal to the first filter 104B. This high frequency response signal reaches the power line communicating unit 308B along a reverse route to the route of the high frequency signal. This configuration allows the converter 100 to carry out the power line communication with the outlet 300B.

Through the above configuration, the converter 100 converts the communication mode of the plug 200 from no communication to the power line communication. In this manner, the converter 100 adjusts the plug 200 to be available for the power line communication. In other words, the plug 200 becomes available to the user even in the environment in which only the power line communication is available to the user.

### 6. Third Application Example

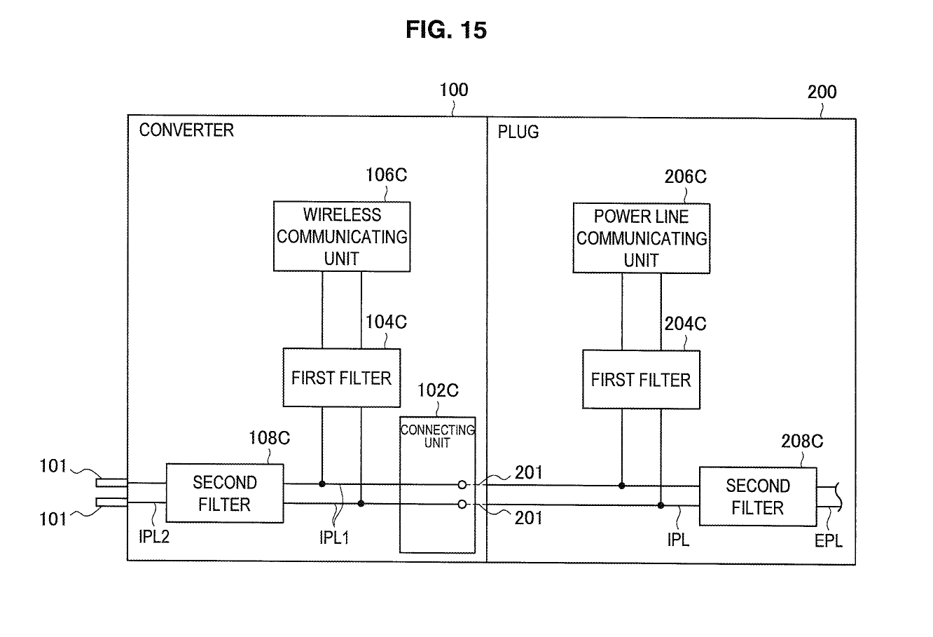

With reference to FIG. 15, the third application example will now be described. The converter 100 includes the blade terminals 101, a connecting unit 102C, a first filter 104C, a wireless communicating unit 106C, a second filter 108C, and the internal power lines IPL1, IPL2. The converter 100 converts the communication mode of the plug 200 having the power line communicating function from the power line communication to the wireless communication. Specifically, the converter 100 adjusts the plug 200 to be available for the wireless communication. The converter 100 is connected to the outlet 300A, for example.

The connecting unit 102C includes the above described apertures 110. The apertures 110 are connected to the second filter 108C through the internal power line IPL1. The internal power line IPL2 connects the blade terminals 101 to the second filter 108C.

The first filter 104C is connected between the wireless communicating unit 106C and the internal power line IPL1, and functions for filtering the signals transmitted from the internal power line IPL1. More specifically, the first filter 104C has a function for blocking the power signal without blocking the high frequency signal and the high frequency response signal among the signals transmitted from the internal power line IPL1. Through this configuration, the first filter 104C prevents the power signal that may be noises to the wireless communicating unit 106C from reaching the wireless communicating unit 106C. The specific configuration of the first filter 104C is the same as that of the above described first filter 104B.

The wireless communicating unit 106C functions as a so-called communicating antenna. The wireless communicating unit 106C has the same specific configuration as that of the above described high frequency transceiver 250. The resonant frequency of the wireless communicating unit 106C may be a frequency of a high frequency signal of 13.56 [MHz], for example. In the above configuration, the wireless communicating unit 106C receives the high frequency signal transmitted from the outlet 300A through the wireless communication, and transmits this high frequency signal to the plug 200 through the power line communication. The wireless communicating unit 106C receives the high frequency response signal transmitted from the plug 200 through the power line communication, and transmits this high frequency response signal to the outlet 300A through the wireless communication.

The second filter 108C connects the internal power line IPL1 to the internal power line IPL2. The second filter 108C functions for filtering the signals to be transmitted through the internal power line IPL1. More specifically, the second filter 108C has a function for blocking the high frequency response signal transmitted from the plug 200 and the high frequency signal transmitted from the wireless communicating unit 106C without blocking the power signal supplied from the outlet 300A. Specifically, the second filter 108C transmits the power signal from the outlet 300A to the electronic equipment when the converter 100 is inserted into the outlet 300A, and the plug 200 is connected to the converter 100. In other words, the second filter 108C functions as a power splitter.

The plug 200 includes the blade terminals 201, a first filter 204C, a power line communicating unit 206C, a second filter 208C, and the internal power line IPL. The blade terminals 201 are connected to the internal power line IPL.

The first filter 204C is connected between the power line communicating unit 206C and the internal power line IPL, and has a function for filtering the signals transmitted from the internal power line IPL. More specifically, the first filter 204C has a function for blocking the power signal without blocking the high frequency signal and the high frequency response signal among the signals transmitted from the internal power line IPL. The specific configuration of the first filter 204C is the same as that of the first filter 104B.

The power line communicating unit 206C operates with the high frequency signal transmitted from the outlet 300A. The power line communicating unit 206C generates the high frequency response signal through the load modulation, and transmits this high frequency response signal to the internal power line IPL. The specific configuration of the power line communicating unit 206C is the same as that of the above described power line communicating unit 106B. In the plug 200 according to the present embodiment, each component included in the IC chip 252 may not be formed in an IC chip.

The second filter 208C connects the external power line EPL extending from the electronic equipment (not shown) to the internal power line IPL. The second filter 208C functions for filtering the signals to be transmitted through the internal power line IPL. More specifically, the second filter 208C has a function for at least blocking the high frequency signal transmitted from the converter 100 and the high frequency response signal transmitted from the power line communicating unit 206C without blocking the power signal supplied from the outlet 300A. The second filter 208C functions as a so-called power splitter. The configuration of the second filter 208C is the same as that of the above described second filter 108B.

Through the above configuration, the converter 100 converts the communication mode of the plug 200 from the power line communication to the wireless communication. Specifically, the converter 100 transmits the high frequency response signal provided by the power line communicating unit 206A of the plug 200 to the outlet 300A through the wireless communication. The converter 100 receives the high frequency signal transmitted from the outlet 300A through the wireless communication, and transmits this high frequency signal to the power line communicating unit 206C through the power line communication. Accordingly, the converter 100 adjusts the plug 200 for the power line communication to be available for the wireless communication. Through this configuration, the plug 200 becomes available to the user even in the environment in which only the wireless communication is available to the user.

The converter 100 may mutually convert the communication standards if the communication standard (such as the format or frequency of the high frequency signal) of the power line communication carried out by the plug 200 is different from the communication standard of the wireless communication carried out by the outlet 300A. In this case, a communication standard converting unit for converting the communication standard may be disposed between the first filter 104C and the wireless communicating unit 106C. This communication standard converting unit is embodied by the same configuration as the above described power line communicating unit 106B. Specifically, the communication standard converting unit converts the format of the high frequency response signal from the plug 200, and transmits the converted high frequency response signal to the wireless communicating unit 106C through the frequency modulation. On the other hand, the communication standard converting unit converts the format of the high frequency signal from the wireless communicating unit 106C, and transmits this high frequency signal to the first filter 104C.

### 7. Fourth Application Example

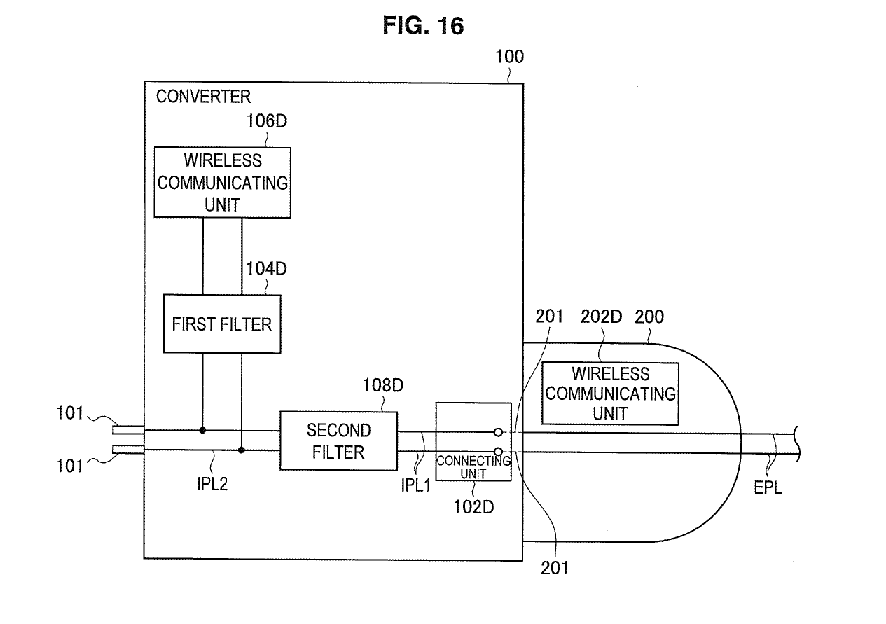

With reference to FIG. 16, the fourth application example will now be described. The converter 100 includes the blade terminals 101, a connecting unit 102D, a first filter 104D, a wireless communicating unit 106D, a second filter 108D, and the internal power lines IPL1, IPL2. The converter 100 converts the communication mode of the plug 200 having a wireless communicating function from the wireless communication to the power line communication. Specifically, the converter 100 adjusts the plug 200 to be available for the power line communication. The converter 100 is connected to the outlet 300B, for example.

The connecting unit 102D includes apertures. The blade terminals 201 of the plug 200 are inserted into these apertures. The apertures are connected to the internal power line IPL 1. The internal power line IPL1 connects the second filter 108D to the connecting unit 102D. The internal power line IPL2 connects the second filter 108D to the blade terminals 101.

The first filter 104D is connected between the wireless communicating unit 106D and the internal power line IPL2, and functions for filtering the signals transmitted from the internal power line IPL2. More specifically, the first filter 104D has a function for blocking the power signal without blocking the high frequency signal and the high frequency response signal among the signals transmitted from the internal power line IPL2. Through this configuration, the first filter 104D prevents the power signal that may be noises to the wireless communicating unit 106D from reaching the wireless communicating unit 106D. The specific configuration of the first filter 104D is the same as that of the above described first filter 104B.

The wireless communicating unit 106D functions as a so-called communicating antenna. The wireless communicating unit 106D has the same configuration as that of the above described high frequency transceiver 250. The wireless communicating unit 106D receives the high frequency signal transmitted from the outlet 300B through the power line communication, and transmits the received high frequency signal to the plug 200 through the wireless communication. In addition, the wireless communicating unit 106D receives the high frequency response signal transmitted from the plug 200 through the wireless communication, and transmits the received high frequency response signal to the outlet 300B through the power line communication.

The second filter 108D connects the internal power line IPL1 to the internal power line IPL2. The second filter 108D functions for filtering the signals to be transmitted from the outlet 300B and the wireless communicating unit 106D. More specifically, the second filter 108D has a function for blocking the high frequency signal and the high frequency response signal transmitted from the outlet 300B and the wireless communicating unit 106D without blocking the power signal supplied from the external power source. In other words, the second filter 108D prevents the high frequency signal transmitted from the outlet 300B and the wireless communicating unit 106D from being transmitted to the electronic equipment.

The plug 200 includes the blade terminals 201 and a wireless communicating unit 202D. The configuration of the wireless communicating unit 202D is the same as that of the above described wireless communicating unit 104A. Specifically, the wireless communicating unit 202D operates with the high frequency signal transmitted from the wireless communicating unit 106D through the wireless communication, and generates the high frequency response signal through the load modulation. The wireless communicating unit 202D transmits the high frequency response signal to the wireless communicating unit 106D through the wireless communication.

Through the above configuration, the converter 100 converts the communication mode of the plug 200 from wireless communication to the power line communication. In this manner, the converter 100 adjusts the plug 200 to the outlet 300B that carries out the power line communication. In other words, the plug 200 becomes available to the user even if the user carries only the outlet 300B for the power line communication with him or her.

The converter 100 may mutually convert the communication standards if the communication standard (such as the format or frequency of the high frequency signal) of the wireless communication carried out by the plug 200 is different from the communication standard of the wireless communication carried out by the outlet 300B. In this case, a communication standard converting unit for converting the communication standard may be disposed between the first filter 104D and the wireless communicating unit 106D. This communication standard converting unit is embodied by the same configuration as the above described power line communicating unit 106B. Specifically, the communication standard converting unit converts the format of the high frequency response signal from the plug 200, and transmits the converted high frequency response signal to the first filter 104D through the frequency modulation. On the other hand, the communication standard converting unit converts the format of the high frequency signal from the first filter 104D, and transmits this high frequency signal to the wireless communicating unit 106D.

As described above, the present embodiment allows the IC chip 252 to carry out various types of communication; thus the converter 100 allows the plug 200 to carry out desirable communication. In addition, the converter 100 restricts the communication carried out by the IC chip 252 if the plug 200 is removed from the apertures 110. Accordingly, the possibility of inconsistency between the information transmitted from the IC chip 252 and the electronic equipment is reduced.

In addition, the converter 100 destroys the IC chip 252 if the plug 200 is removed from the apertures, thereby securely reducing the possibility of inconsistency between the information transmitted from the IC chip 252 and the electronic equipment.

The converter 100 fixes the plug 200 with the plug 200 connected to the apertures 110, and destroys the IC chip 252 if the fixation of the plug 200 is released, thereby securely reducing the possibility of inconsistency between the information transmitted from the IC chip 252 and the electronic equipment.

The fixing member 400 is inserted into the first through holes 202 and the second through hole 120, and the IC chip 252 is disposed at the tip end of the fixing member 400. Accordingly, the IC chip 252 is easily destroyed by the fixing member 400 simply by moving the fixing member 400 to the IC chip 252.

The fixing member 400 includes the auxiliary fixing members 401 for fixing the base body 400a in the first through holes 202 and in the second through hole 120. This configuration allows the fixing member 400 to fix the blade terminals 201 of the plug 200 in the apertures 110.

The auxiliary fixing members 401 allow the base body 400a to move toward the IC chip 252, and restrict the base body 400a to move apart from the IC chip 252 at the same time. Accordingly, the auxiliary fixing members 401 more securely prevent the plug 200 from being removed until the IC chip 252 is destroyed.

The base body 400a is movable toward the IC chip 252 by using the unlocking member 500. Accordingly, this unlocking member 500 allows the user to destroy the IC chip 252.

The IC chip 252 is capable of carrying out the communication pertinent to the plug 200, specifically, the communication with the electronic equipment connected to the plug 200. Accordingly, the converter 100 is capable of carrying out the above described processing on the IC chip 252.

The converter 100 is capable of carrying out the above described processing on the IC chip having the wireless communicating function. In addition, the converter 100 is capable of carrying out the above described processing on the IC chip 252 having the power line communicating function.

With reference to the appended drawings, the preferred embodiment of the present disclosure have been described in detail, but the technical scope of the present disclosure is not limited to the examples of the embodiment. It should be understood by those skilled in the art that various modifications, combinations, sub-combinations and alterations may occur depending on design requirements and other factors insofar as they are within the scope of the appended claims or the equivalents thereof.

For example, in the above embodiment, the outlet and the plug are used as an example of the connecting device, but the technology according to an embodiment of the present disclosure may be applicable to other connecting device. For example, the technology according to an embodiment of the present disclosure may be applicable to such connecting device that connects a battery of an electric vehicle to an external power source. The above described converter is a so-called converting adaptor, and an extension code may be provided with a function of each converter.

Additionally, the present technology may also be configured as below.

(1) A converter including:

a connecting terminal connectable to a connecting device;

a communicating unit capable of carrying out communication; and

a communication restricting unit configured to restrict the communication carried out by the communicating unit if the connecting device is removed from the connecting terminal.

(2) The converter according to (1), wherein
the communication restricting unit destroys the communicating unit, or blocks the communication carried out by the communicating unit if the connecting device is removed from the connecting terminal.
   (3) The converter according to (2), wherein

the communication restricting unit fixes the connecting device in a state that the connecting device is connected to the connecting terminal, and

the communication restricting unit destroys the communicating unit, or blocks the communication carried out by the communicating unit if the connecting device is removed from the connecting terminal.

(4) The converter according to (3), wherein

the connecting device includes
a projection, and
a first through hole formed in the projection,

the connecting terminal is an aperture into which the projection is inserted,

the communication restricting unit includes
a second through hole configured to be coupled with the first through hole if the projection is inserted into the aperture, and
a fixing member configured to fix the projection in the aperture if the fixing member is inserted into the first through hole and the second through hole, and

the communicating unit is disposed at a tip end of the fixing member.

(5) The converter according to (4), wherein

the fixing member includes
a base body configured to be inserted into the first through hole and the second through hole, and
an auxiliary fixing member configured to fix the base body in the first through hole and the second through hole.
   (6) The converter according to (5), wherein

the auxiliary fixing member allows the base body to move toward the communicating unit, and restricts the base body to move apart from the communicating unit.

(7) The converter according to (6), wherein

the base body is configured to be movable toward the communicating unit through an unlocking member.

(8) The converter according to any one of (1) to (7), wherein

the communicating unit is capable of carrying out communication pertinent to the connecting device.

(9) The converter according to any one of (1) to (7), wherein

the communicating unit is capable of carrying out wireless communication.

(10) The converter according to any one of (1) to (7), wherein

the communicating unit is capable of carrying out power line communication.

(11) A program allowing a computer to realize a communication restriction to restrict communication carried out by a communicating unit if a connecting device connectable to a connecting terminal is removed from the connecting terminal.

The present disclosure contains subject matter related to that disclosed in Japanese Priority Patent Application JP 2012-028784 filed in the Japan Patent Office on Feb. 13, 2012, the entire content of which is hereby incorporated by reference.

What is claimed is:

1. A converter comprising:
a connecting terminal connectable to a connecting device;
a communicating unit capable of carrying out communication; and
a communication restricting unit configured to restrict the communication carried out by the communicating unit if the connecting device is removed from the connecting terminal.

2. The converter according to claim 1, wherein
the communication restricting unit destroys the communicating unit, or blocks the communication carried out by the communicating unit if the connecting device is removed from the connecting terminal.

3. The converter according to claim 2, wherein
the communication restricting unit fixes the connecting device in a state that the connecting device is connected to the connecting terminal, and
the communication restricting unit destroys the communicating unit, or blocks the communication carried out by the communicating unit if the connecting device is removed from the connecting terminal.

4. The converter according to claim 3, wherein
the connecting device includes
a projection, and
a first through hole formed in the projection,
the connecting terminal is an aperture into which the projection is inserted,
the communication restricting unit includes
a second through hole configured to be coupled with the first through hole if the projection is inserted into the aperture, and
a fixing member configured to fix the projection in the aperture if the fixing member is inserted into the first through hole and the second through hole, and
the communicating unit is disposed at a tip end of the fixing member.

5. The converter according to claim 4, wherein
the fixing member includes
a base body configured to be inserted into the first through hole and the second through hole, and
an auxiliary fixing member configured to fix the base body in the first through hole and the second through hole.

6. The converter according to claim 5, wherein
the auxiliary fixing member allows the base body to move toward the communicating unit, and restricts the base body to move apart from the communicating unit.

7. The converter according to claim 6, wherein
the base body is configured to be movable toward the communicating unit through an unlocking member.

8. The converter according to claim 1, wherein
the communicating unit is capable of carrying out communication pertinent to the connecting device.

9. The converter according to claim 1, wherein
the communicating unit is capable of carrying out wireless communication.

10. The converter according to claim 1, wherein
the communicating unit is capable of carrying out power line communication.

11. A program allowing a computer to realize a communication restriction to restrict communication carried out by a communicating unit if a connecting device connectable to a connecting terminal is removed from the connecting terminal.
